(19) United States
(12) Patent Application Publication
(10) Pub. No.: US 2006/0020676 A1
(43) Pub. Date: Jan. 26, 2006

(54) System and method for presenting a chat user name with multiple user service names

(75) Inventors: Nathan J. Peterson, Raleigh, NC (US); Rod David Waltermann, Durham, NC (US); Arnold S. Weksler, Raliegh, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 10/894,520

(22) Filed: Jul. 20, 2004

(51) Int. Cl. G06F 15/16

(52) U.S. Cl. 709/207

(57) ABSTRACT

If a chat user has multiple chat services, a chat partner can list the user name of each service under a single generic user name for display. The service user name with the “best” service as indicated by heuristics including, e.g., activity, security, etc. is invoked whenever the chat partner uses the generic user name to address the chat user.

### I. FIELD OF THE INVENTION

The present invention relates generally to chat systems.

### II. BACKGROUND OF THE INVENTION

A variety of communication methods by the use of computer networks have been developed in recent years in accordance with the growth of the Internet. Such methods include chat systems, multi-user and real-time communication methods. Chat systems have widely replaced traditional telephones and electronic mail. A chat system, informally known as “Chat,” is a means through which typed conversation is sent from sender to recipient via a computer network, namely the Internet, almost instantly.

A client computer may be linked to a network through a server computer. Such a client computer running a software application allowing one user to chat with another user on the same network can be termed a “chat client.” “A virtual space” may be defined as the chat network created by the users chatting via chat clients and matching servers. A conversation forum, or channel, is created between the users chatting via the chat clients, also called chat partners. This conversation forum exists in the server and as chat partners converse in real time. Thus, a “chat system” is a communication method characterized by chat partners who share numerous virtual spaces.

The chat partner is identified by a user-chosen chat service name. As recognized herein, a chat partner may chat by means of multiple chat services and therefore can have multiple service names. Unfortunately, when a user wishes to send a chat message to another user having multiple chat services, the sender must determine which chat service to use to send the message, and/or determine which chat service the receiver is logged into.

### SUMMARY OF THE INVENTION

A computer-implemented method includes correlating at least first and second user service names to a single user name. Each user service name is associated with a respective chat service. When the single user name is invoked, one of the chat services, preferably a “best” service, is invoked.

In non-limiting embodiments the chat service can be invoked by selecting the associated user service name when the single user name is invoked. The method may include determining which service has a best service based on respective service activities, and/or respective service securities, and/or respective qualities of service. When qualities of service are used, they may be selected from the group including latency, throughput, error rate, and link availability. If desired, an icon representing a best service can be displayed to a user.

In another aspect, a service includes determining a best chat service from among plural chat services accessed by a single user, and returning to the user an indication representing the best chat service.

In still another aspect, a system includes at least one chat user computer and plural chat services communicating with the chat user computer. Service selection means are provided for selecting one of the plural chat services to use to chat with another chat user.

In another aspect, a computer-implemented method includes correlating at least first and second user service names to a single user name, with each user service name being associated with a respective chat service. The method includes displaying a list including at least one user name and plural user service names associated with the user name.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a system for undertaking the present invention;

FIG. 2 is a flow chart of the logic for establishing multiple user service names for a single user name; and

FIG. 3 is a schematic diagram of a screen display showing several user service names under a single user name.

### DETAILED DESCRIPTION OF THE PREFERRED EMBODIMENT

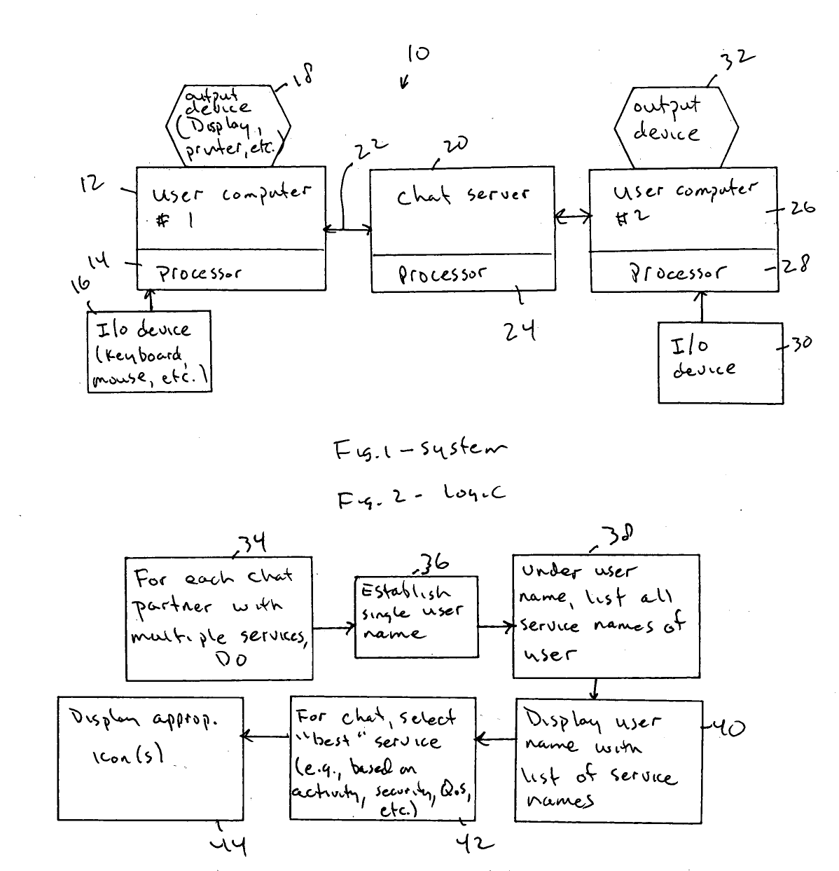

Referring initially to FIG. 1, a system is shown, generally designated 10, that includes a first user computer 12 having one or more processors 14 receiving user input from an input device 16, such as but not limited to one or more of a keyboard, mouse, keypad, voice recognition device, etc. The user computer 12 also has an output device 18 such as but not limited to one or more of a computer monitor, audio speaker, printer, computer, or computer network. The processor 14 of the user computer 12 executes computer software application programs such as Web browsers and chat software.

The first user computer 12 may communicate with a server 20 over a communication path 22 such as the Internet. In the embodiment shown, the server 20 is a chat server that includes one or more processors 24. In turn, the chat server 20 can communicate with a second user computer 26 that has a processor 28, input device 30, and output device 32.

It is to be understood that while only two user computers are shown, more user computers and more chat servers may be implemented in the present invention. The computers shown herein may be any suitable computers, e.g., personal computers, server computers, laptop computers, etc. It is to be further understood that at least portions of the inventive logic divulged herein may be executed by one or more of the processors shown in FIG. 1. Thus, the invention may be embodied as a computer-implemented method, a general purpose computer programmed to undertake the method, and a computer program product (i.e., an article of manufacture) such as a computer storage device that holds computer code such as but not limited to C++ or Java that embodies the present logic. The computer storage device may be a magnetic or optical disk in a disk drive, a floppy diskette, or solid state storage accessible by the associated processors in accordance with principles known in the art. The user computers 12, 26 may communicate with each other through the chat server 20 or may communicate directly with each other.

Now referring to FIG. 2, commencing at block 34 a DO loop is entered for each chat partner that has multiple chat services. The chat partner may have more than one service name, each being associated with a respective chat service. The chat partner may be given a single user name, seen in block 36. This single user name is distinguished from the service name or service names. Moving to block 38, if there is more than one service name, the multiple service names are listed under the single user name. Block 40 indicates that the list of service names is displayed with the single user name. When the “Chat” method of communication is used to communicate with a chat partner, the single user name is invoked, preferably invoking the chat service having the best service, shown in block 42.

Determining which chat service has the best, or optimum, service can be based on respective service activities, e.g., which service the intended recipient is actually logged into. Or, determining which chat service has the best, or optimum, service can be based on respective service securities. For instance, if the intended recipient is logged in to more than one service, the service with the highest security can be selected. Yet again, the “best” service can be selected based on the respective qualities of service. To illustrate, the qualities of service can be selected from the group including latency, throughput, error rate, and link availability. Link availability may be, e.g., “available” or “not available”, link data throughput may be in bits or bytes per second, link error rate may be in terms of number of errors per unit data or unit time, and link latency may be in terms of average or peak time periods to convey a message or unit of data over the link.

Moving to block 44, once the best chat service and the corresponding service name is selected, an appropriate icon can be displayed indicating the best chat service. Appropriate icons for the best service may include a happy, smiling face and the appropriate icons for the less than optimum services may include a sad, frowning face.

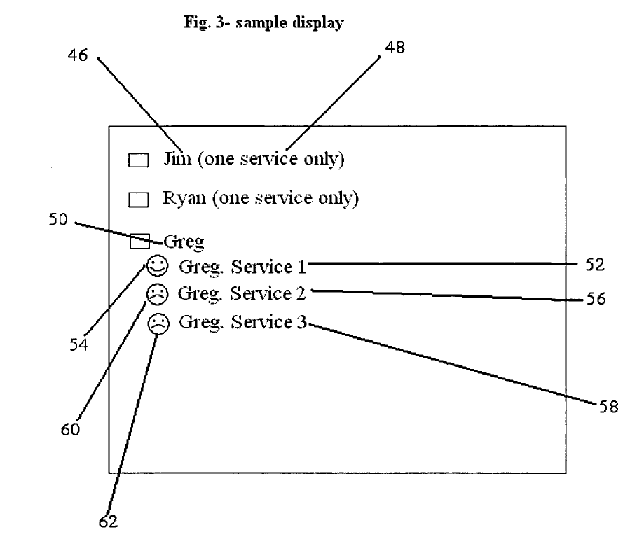

This is illustrated in FIG. 3, wherein a sample display that can be presented on the monitor 18 shown in FIG. 1 includes a user name “Jim” 46. The chat partner under the user name 46 may be called “Chat Partner Jim”. Next to “Chat Partner Jim's” user name 46, the words “one service only” 48 are displayed, indicating that “Chat Partner Jim” is chatting using only one chat service and one respective service name. Additional single service chat partners may likewise be displayed.

On the other hand, “Chat Partner Greg” is displayed under the user name Greg 50. As shown in FIG. 3, “Chat Partner Greg” uses three chat services, each listed under the single user name Greg 50. A first one 52 of “Chat Partner Greg's” chat services is displayed using the service name “Greg.Service1” 52. The service name “Greg.Service1” indicates one of three chat services used by “Chat Partner Greg”. Also, the service corresponding to the service name “Greg.Service1” is indicated as being the best chat service in accordance with principles set forth above by an appropriate icon 54, e.g., a happy, smiling face.

Additionally, two other chat services 56, 58 are listed by respective service names under the single user name “Greg”. In the exemplary embodiment shown, the other chat services listed, “Greg.Service2” and “Greg.Service3” are indicated to be the less than optimum chat services by the appropriate icons 60, 62, e.g., sad, frowning faces.

It is to be understood that the present invention may be provided as a service. For instance, a service provider may operate the chat server 20, and the server 20 can determine which chat service of a user is currently the “best” service as indicated above, and provide this information to the chat clients. Or, the determination can be made by each client computer. Also, a default “best” service can be defined for a user having multiple services. For instance, the default “best” service may dictate that chat with a particular user is always over the service having the highest security, when that service is available to chat with the associated user.

While the particular SYSTEM AND METHOD FOR PRESENTING A CHAT USER NAME WITH MULTIPLE USER SERVICE NAMES as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A computer-implemented method, comprising:
correlating at least first and second user service names to a single user name, each user service name being associated with a respective chat service; and
when the single user name is invoked, invoking at least one of the chat services.

2. The method of claim 1, wherein the chat service is invoked by selecting the associated user service name when the single user name is invoked.

3. The method of claim 1, comprising determining which service has a best service based at least in part on respective service activities, and invoking the best service.

4. The method of claim 1, comprising determining which service has a best service based at least in part on respective service securities, and invoking the best service.

5. The method of claim 1, comprising determining which service has a best service based at least in part on respective service qualities of service and invoking the best service, the qualities of service being selected from the group consisting of latency, throughput, error rate, and link availability.

6. The method of claim 1, comprising displaying at least one icon representing a best service.

7. The method of claim 1, comprising displaying a list including at least one user name and plural user service names associated with the user name.

8. A computer-implemented method, comprising:
correlating at least first and second user service names to a single user name, each user service name being associated with a respective chat service; and
displaying a list including at least one user name and plural user service names associated with the user name.

9. The method of claim 8, wherein when the single user name is invoked, at least one of the chat services is invoked.

10. A service, comprising:
determining a best chat service from among plural chat services accessed by a single user; and
returning to the user an indication representing the best chat service.

11. The service of claim 10, wherein a chat service is invoked by selecting an associated user service name when a single user name is invoked.

12. The service of claim 10, comprising determining which chat service is a best chat service based at least in part on respective service activities.

13. The service of claim 10, comprising determining which chat service is a best chat service based at least in part on respective service securities.

14. The service of claim 10, comprising determining which chat service is a best chat service based at least in part on respective service qualities of service, the qualities of service being selected from the group consisting of latency, throughput, error rate, and link availability.

15. The service of claim 10, comprising displaying at least one icon representing the best chat service.

16. A system comprising:
at least one chat user computer;
plural chat services communicating with the chat user computer; and
means for displaying respective service names of the plural chat services on a single presentation to at least one chat partner communicating with the chat user computer.

17. The system of claim 16, comprising at least one chat server communicating with the chat user computer.

18. The system of claim 17, wherein the server includes means for selecting one of the chat services.

19. The system of claim 16, wherein a chat user computer includes means for selecting one of the chat services.

20. The system of claim 16, comprising service selection means for determining which service has a best service for selection thereof based at least in part on at least one of: respective service activities, respective service securities, and respective service qualities of service, the qualities of service being selected from the group consisting of latency, throughput, error rate, and link availability.
